(19) United States
(12) Patent Application Publication
(10) Pub. No.: US 2005/0281969 A1
(43) Pub. Date: Dec. 22, 2005

(54) Container having enhanced carbon dioxide retention for packaging a beverage, a packaged beverage, and methods

(76) Inventor: Yu Shi, Alpharetta, GA (US)

Correspondence Address: SUTHERLAND ASBILL & BRENNAN LLP, 999 PEACHTREE STREET, N.E., ATLANTA, GA, 30309, US

(21) Appl. No.: 11/143,095

(22) Filed: Jun. 2, 2005

Related U.S. Application Data
(60) Provisional application No. 60/577,513, filed on Jun. 7, 2004.

(51) Int. Cl. B65D 1/00; F16L 1/00; B32B 1/08; B29D 22/00; B29D 23/00; B65D 35/28

(52) U.S. Cl. 428/35.8

(57) ABSTRACT

A container for a carbonated beverage comprises a closure which optionally comprises a closure liner, a container body having a sidewall comprising a polyester composition suitable for packaging a carbonated beverage, and a porous, absorptive inorganic additive which is disposed in the closure, the closure liner, the side wall, or combinations thereof, and is capable of absorbing carbon dioxide. Such a container is well suited for packaging aqueous carbonated beverages to replace at least a portion of carbon dioxide that is lost from the packaged beverage via permeation. Thus, a packaged carbonated beverage and a corresponding method of packaging a carbonated beverage are also disclosed.

### CROSS-REFERENCE TO RELATED APPLICATIONS

This application claims priority under 35 U.S.C. §119(e) to U.S. Provisional Application 60/577,513 filed on Jun. 7, 2004, the disclosure of which is expressly incorporated by reference in its entirety.

### FIELD OF THE INVENTION

This invention relates to packaged aqueous carbonated beverages and more particularly to enhancing the carbon dioxide retention of such beverages and thereby increasing their shelf life.

### BACKGROUND OF THE INVENTION

Poly(ethylene terephthalate) based copolyesters (PET) have been widely used to make containers for carbonated soft drink, juice, water and the like due to their excellent combination of clarity, mechanical and gas barrier properties. In spite of these positive characteristics, further application of PET for smaller sized packages, as well as for oxygen sensitive products, such as beer, juice and tea products, are limited by the insufficient gas barrier of PET to oxygen and carbon dioxide. A widely expressed need exists in the packaging industry to further improve the gas barrier properties of PET.

The use of PET containers for the carbonated soft drink (CSD) has been limited due to the fact that carbon dioxide can permeate through a PET container fairly quickly. The permeation rate of the carbon dioxide in a CSD through a PET container at room temperature is in the range of 3 to 14 cc/day depending on the size of the container, or at a relative loss rate of 1.5 to 2.0%/week when normalized to the starting carbon dioxide level. The relative loss rate depends on the container size, or rather the surface area to volume ratio. The higher the surface area to volume ratio, the higher the relative loss rate. A smaller sized container has a larger surface area/volume ratio thus resulting in a higher relative loss rate. For this reason, PET containers are currently used only as larger sized containers for CSD while metal cans and glass containers are the choice of the smaller sized packages.

The shelf life of a bottled CSD is determined by the amount of carbon dioxide remaining in the beverage. Normally for a CSD, the containers are filled with a carbon dioxide level of 4 volumes carbon dioxide/volume H₂O (which is conveniently called 4 volumes of carbon dioxide). When 17.5% of carbon dioxide in the bottle is lost or a carbon dioxide level of 3.3 volumes is reached due to carbon dioxide permeation through the container sidewall and closure, the product reaches the end of its shelf life. For example, a 500 ml container filled with 4 volumes carbon dioxide/volume H₂O has a total of 350 ml of carbon dioxide to lose. A PET container with a polypropylene closure loses about 0.5 cc of carbon dioxide per day at room temperature, which translates into 10 to 11 weeks of shelf live at room temperature. At elevated temperature, the shelf life will be dramatically reduced. In the case of beverages with lower carbonation levels, a carbon dioxide level of 2 to 2.5 volumes carbon dioxide/volume H₂O is normally required and a certain amount of carbon dioxide loss marks the shelf life of the products. In all the cases, the amount of carbon dioxide left in the container determines the shelf life of the beverage and thus the suitability of PET as a packaging material.

To prevent the carbon dioxide loss, there have been many barrier technologies developed or being developed that try to enhance the barrier of the PET containers to small molecules such as carbon dioxide. Regardless of the mechanisms, these barrier technologies all intend to slow down the permeation of carbon dioxide through the container sidewall or slow down the loss of carbon dioxide inside the container. This, however, does not change the total amount of carbon dioxide that the beverage can afford to lose for the beverage product to have an acceptable quality. As explained above, for a 500 ml bottle filled with 4 volumes of carbon dioxide/volume of water, the amount of carbon dioxide loss that can be tolerated before the product reaches its maximum shelf life is 350 ml. The barrier technologies only extend the time it takes this amount of carbon dioxide loss through the sidewall and closure. The total amount of tolerable carbon dioxide loss, 350 cc of carbon dioxide, will not change based on different barrier technologies used. In addition, almost all of the practically available barrier technologies today require capital investment and add substantial cost to container manufacture.

U.S. Pat. No. 5,855,942 discloses a method and composition for enhancing the retention of carbon dioxide in carbonated beverages via addition of a carbonic acid ester in the beverage. The carbonic acid esters release carbon dioxide through the acid catalyzed hydrolysis of the carbonic acid ester in the acid aqueous environment of the carbonated beverage. The release of carbon dioxide is claimed to occur at the similar rate of carbon dioxide permeation through the sidewall.

The above technologies, while generating carbon dioxide to compensate the carbon dioxide loss through the sidewall and closure, are not practical and are very difficult to use. The addition of any compound in the beverage alters the beverage composition. The composition keeps changing as the hydrolysis of the carbonic acid ester continues. Alteration of the beverage not only dramatically affects the taste and the nature of the beverage, but the added compounds also have to be compatible with the beverage product so that no solid deposits form and cloud the beverage product. Changing the beverage composition can also create regulatory issues, if the additives are not compliant with the regulations or form toxic by-products as a result of the reaction.

Thus, there remains a need for a simple and effective system of compensating for carbon dioxide loss in packaged CSD without adversely affecting the CSD composition.

### SUMMARY OF THE INVENTION

This invention addresses the above-described need by providing a container for a carbonated beverage comprising a closure which optionally comprises a closure liner, a container body having a sidewall comprising a polyester composition suitable for packaging a carbonated beverage, and a porous, absorptive inorganic additive which is disposed in the closure, the closure liner, the side wall, or combinations thereof, and is capable of absorbing carbon dioxide. Such a container is well suited for packaging aqueous carbonated beverages to replace at least a portion of carbon dioxide that is lost from the packaged beverage via permeation.

Thus, according to an embodiment of this invention, a packaged aqueous carbonated beverage is provided and comprises a container which replaces at least a portion of carbon dioxide that permeates through the container or closure. More particularly, the packaged carbonated beverage comprises a container body, a closure which seals the container body, optionally a closure liner, and a porous, absorptive inorganic additive capable of absorbing carbon dioxide. The container body has a sidewall comprising a polyester composition suitable for packaging a carbonated beverage. The closure seals the container body and optionally comprises a closure liner. The absorptive inorganic additive is disposed in the closure, the closure liner, the side wall, or combinations thereof. The absorptive inorganic additive has been saturated with carbon dioxide under pressure prior to or immediately after filling the container body with the carbonated beverage as described in the examples below. The carbonated beverage is disposed in the container body and the absorptive inorganic additive releases carbon dioxide for replacing at least a portion of carbon dioxide that permeates through the container or closure. The absorptive inorganic additive thereby enhances carbon dioxide retention in the beverage package and extends the carbon dioxide retention and shelf life of the beverage without altering the composition of the beverage.

This invention further comprises a corresponding method of enhancing carbon dioxide retention in a carbonated beverage comprising the steps of providing a container comprising a porous, absorptive inorganic additive capable of absorbing carbon dioxide, prior to or immediately after filling the container, saturating the absorptive inorganic additive with carbon dioxide, filling the container with a carbonated beverage, and sealing the container, wherein carbon dioxide absorbed by the absorptive inorganic additive is released into the container compensating at least in part for loss of carbon dioxide from the carbonated beverage by permeation through the container. The container comprises a (a) closure optionally comprising a closure liner, (b) a container body having a sidewall comprising a polyester composition suitable for packaging a carbonated beverage, and (c) the porous, absorptive inorganic additive which is disposed in the closure, the closure liner, the side wall, or combinations thereof.

Other objects, features, and advantages of this invention will become apparent from the following detailed description, drawings, and claims.

### BRIEF DESCRIPTION OF THE DRAWINGS

FIG. 1 is a sectional elevational view of a molded container preform made in accordance with an embodiment of this invention.

FIG. 2 is a sectional elevational view of a blow molded container made from the preform of FIG. 1 in accordance with an embodiment of this invention.

FIG. 3 is a perspective view of a packaged beverage made in accordance with an embodiment of this invention.

FIG. 4 is a graph illustrating carbon dioxide desorption in accordance with an embodiment of this invention.

FIG. 5 is a graph illustrating carbon dioxide desorption in accordance with another embodiment of this invention.

FIG. 6 is a graph illustrating carbon dioxide desorption in accordance with another embodiment of this invention.

### DETAILED DESCRIPTION OF THE INVENTION

As summarized above, the present invention encompasses a container that is useful for packaging an aqueous carbonated beverage. The container comprises a closure which optionally comprises a closure liner, a container body having a sidewall comprising a polyester composition suitable for packaging a carbonated beverage, and a porous, absorptive inorganic additive which is disposed in the closure, the closure liner, the side wall, or combinations thereof, and is capable of absorbing carbon dioxide. Once the absorptive inorganic additive is incorporated into the container body side wall or the closure or closure liner, the absorptive inorganic additive is saturated with high pressure or high concentration carbon dioxide prior to or immediately after filling the container with carbonated beverage. The carbon dioxide absorbed into the absorptive additive is slowly released as the pressure or the carbon dioxide concentration around the additive drops and a pressure or concentration gradient is formed. The carbon dioxide desorption from the absorptive additives occurs from the high concentration spots of the porous, absorptive additive to the surrounding areas and slowly released to the inside of container to replenish the loss of carbon dioxide through the container sidewall or the closure. This extends the shelf-life of the packaged beverage.

Such a container as described hereinbefore is well suited for packaging carbonated beverages to replace at least a portion of carbon dioxide that is lost from the packaged beverage via permeation. This invention further encompasses a packaged beverage comprising a carbonated beverage disposed in the above-described container. Furthermore, this invention encompasses a method for enhancing carbon dioxide retention in a carbonated beverage.

The polyester composition for making the container body comprises any polyester that is suitable for packaging aqueous carbonated beverages and has carbon dioxide loss through permeation of the sidewall and/or closure. In preferred embodiments, the polyester is a poly(ethylene terephthalate) based copolyester (PET copolyester) having less than 20 mole % diacid and/or 10 mole % diol modification, based on 100 mole % diacid component and 100 mole % diol component. In other words, in one preferred embodiment, the polyester is PET copolyester having less than 20 mole % diacid modification, based on 100 mole % diacid component and 100 mole % diol component. In another preferred embodiment, the polyester is PET copolyester having less than 10 mole % diol modification, based on 100 mole % diacid component and 100 mole % diol component. In yet another embodiment, the polyester is PET copolyester having less than 20 mole % diacid and less than 10 mole % diol modification, based on 100 mole % diacid component and 100 mole % diol component. Diacid modifiers that may be added to the PET copolyester include but are not limited to adipic acid, succinic acid, isophthalic acid, phthalic acid, 4,4′-biphenyl dicarboxylic acid, 2,6-naphthalenedicarboxylic acid, and the like. Suitable diol modifiers include but are not limited to cyclohexanedimethanol, diethylene glycol, 1,2-propanediol, neopentylene glycol, 1,3-propanediol, and 1,4-butanediol, and the like. As will be explained in further detail below, the absorptive inorganic additive can be incorporated into the PET matrix of the container body during formation of the container body.

The closure for the container can be any closure conventionally used to seal carbonated beverages in a PET container body. In preferred embodiments, the closure is a plastic cap made from a rigid polymer such as polypropylene or high density polyethylene, although it can be made from a variety of polymers and copolymers. The absorptive inorganic additive can be incorporated into the polymer matrix of the closure in addition to or as an alternative to incorporating the absorptive inorganic additive into the container PET body.

Optionally, the closure may comprise a liner for enhancing the seal between the closure and the container body and the releasability of the closure from the container body. The liner can be any closure liner conventionally used to seal carbonated beverages in a PET container body, such as but not limited to ethylene vinyl acetate copolymer. In preferred embodiments, the closure liner is a relatively soft polymeric film made from a polyolefin copolymer such as ethylene vinyl acetate copolymer, although it can be made from a variety of polymers and copolymers. The absorptive inorganic additive can be incorporated into the polymer matrix of the liner in addition to or as an alternative to incorporating the absorptive inorganic additive into the container PET body or closure.

The absorptive inorganic additive can be any porous particles that can absorb carbon dioxide to a substantial level. A preferred inorganic additive is highly absorptive and has a surface area greater than 100 m²/g and more preferably greater than 150 m²/g. The preferred absorptive inorganic additives are inert during melt processing of the polymeric materials used for the container, closure or closure liner and will not degrade at the processing temperatures during melt processing, such as injection molding, blow molding and compression molding. The preferred absorptive inorganic additives, therefore, are those that do not react with polyesters used to make the container bodies, or polypropylene and high density polyethylene used for the closures, or polymers such as ethylene vinyl acetate copolymer used to make the liners, and do not degrade at temperatures up to 300° C.

The absorptive inorganic additive is incorporated into the container body side wall, closure or liner in an amount sufficient to absorb and then release carbon dioxide into the container filled with carbonated beverage in an amount and for a time to enhance the shelf life of a packaged carbonated beverage. The absorptive inorganic additive is preferably incorporated into the container body side wall, closure or liner in an amount from about 3% to about 50% by weight, more preferably at levels from about 3% to about 20% by weight, further more preferably from about 3% to about 10% by weight of the respective container body side wall, closure or liner. The absorptive inorganic additives are desirably highly absorptive. Examples of such absorptive inorganic additives include, but are not limited to zeolite and fumed silica.

Once the absorptive inorganic additive is incorporated into the container side wall or the closure or closure liner, the additive containing part is saturated with high pressure or high concentration carbon dioxide prior to filling the container with carbonated beverage. In one embodiment, the absorptive inorganic additive containing part is stored in a chamber filled with high pressure carbon dioxide until the additive is saturated with carbon dioxide. Preferably, the chamber is filled with carbon dioxide at room temperature and a pressure from about 60 psi to about 150 psi. In another embodiment, the container is filled with carbon dioxide with pressure above 60 psi, preferrably above 65 psi and then capped. The absorptive additive is incorporated in the container, the closure or the closure liner, or the combination thereof.

Although the absorptive inorganic additives can be incorporated into container sidewall, the closure or the closure liner, the best performance is expected from the incorporation of the additives to the closure liner. Both container sidewall and the closure, in addition to having surfaces that are exposed to the inside of the container, have free surfaces exposed to the air outside the container. Carbon dioxide is released from the absorptive additive to the inside the container as well as to the outside air. Thus, some of the effect is lost due to these air exposed free surfaces. For closure liners, the only free surface is exposed to the inside of the container, thus making this embodiment more effective.

As is well known to those skilled in the art, containers can be made by blow molding a container preform. Examples of suitable preform and container structures are disclosed in U.S. Pat. No. 5,888,598, the disclosure of which is expressly incorporated herein by reference in its entirety.

When incorporated into a container body, the absorptive inorganic additive is added to the polyester during the production of the preforms through either a one-step or two-step injection blow molding process. There are several ways of incorporating the absorptive additives. In one embodiment, a polyester composition comprising the polyester and the carbonating agent is formed first and converted to a transportable form, like solid pellets, followed by heating the solid polyester composition and molding the polyester composition into a container perform. In another embodiment, the absorptive inorganic additive and polyester are dried separately prior to mixing. The absorptive inorganic additive is then mixed with polyester prior to injection molding, and a polyester preform is made from the mixture. The preforms molded from the polyester composition are then blown into containers using a commercial or lab blow molding machine. Certain adjustments in the blow molding conditions will be needed to make suitable containers. To those skilled in the art, the adjustments are a common practice. During a one-step injection stretch molding process, the absorptive inorganic additive is mixed with polyester prior to injection molding and preforms and bottles are produced thereafter. The containers are then filled with an aqueous carbonated beverage in accordance with conventional methods. In the containers, the aqueous carbonated beverage is in direct contact with the polyester composition which forms the containers.

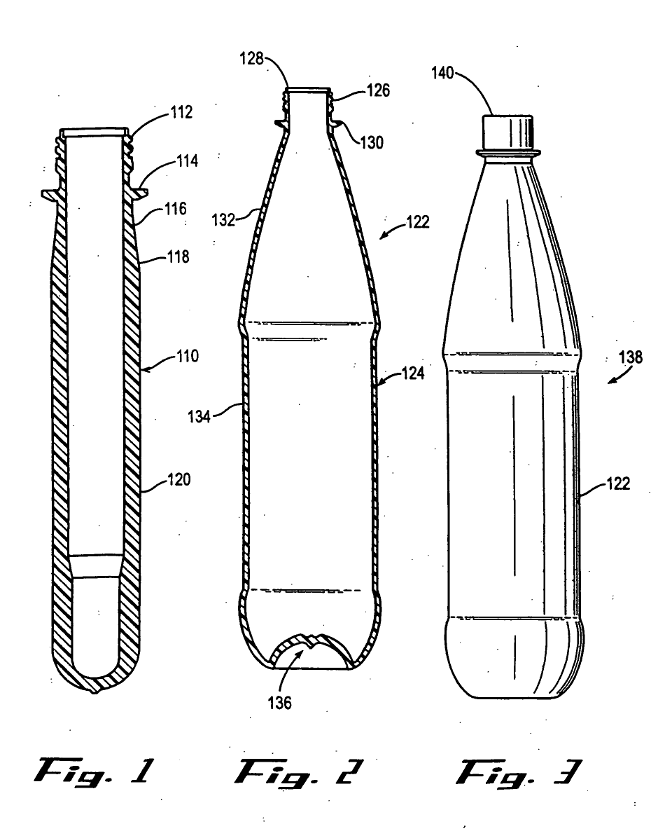

Turning to FIG. 1, a container preform 110 is illustrated. This preform 110 is made by molding the polyester resin and comprises a threaded neck finish 112 which terminates at its lower end in a capping flange 114. Below the capping flange 114, there is a generally cylindrical section 116 which terminates in a section 118 of gradually increasing external diameter so as to provide for an increasing wall thickness. Below the section 118 there is an elongated body section 120.

The preform 110 illustrated in FIG. 1 can be blow molded to form a container 122 illustrated in FIG. 2. The container 122 comprises a container body 124 comprising a threaded neck finish 126 defining a mouth 128, a capping flange 130 below the threaded neck finish, a tapered section 132 extending from the capping flange, a body section 134 extending below the tapered section, and a base 136 at the bottom of the container. The container 122 is suitably used to make a packaged beverage 138, as illustrated in FIG. 3. The packaged beverage 138 includes a beverage such as carbonated soda beverage disposed in the container 122 and a closure 140 sealing the mouth 128 of the container.

The closure 140 also includes a thermoplastic liner (not shown) disposed in the interior of the closure against the top of the closure. The liner creates a fluid-tight seal between the mouth of the container 122 and the closure 140 when the closure is threaded tightly onto the neck finish 126 of the container. Such liners are well known.

The closure 140 can be made of materials such as metal or glass, but is desirably made of a thermoplastic material. Suitable thermoplastic materials for the cap include polypropylene, polyethylene such as high density polyethylene, PET, polystyrene, and the like. The closure 140 is made by conventional means of injection molding or compression molding understood by those skilled in the art.

The thermoplastic liner is made and deposited inside the closure 140 by conventional means. For example, the liner can be compression molded and then inserted into the closure 140 or the liner can be formed in situ by depositing heated thermoplastic liner material in the closure and pressing the thermoplastic material against the top of the closure.

Suitable thermoplastic to form the polymer matrix of the liner include ethylene vinyl acetate (EVA), polyvinyl chloride (PVC), PET, polyethylene, polypropylene, polyurethane, copolymers of vinyl chloride and vinyl acetate, ethylecellulose, cellulose acetate, cellulose acetate butyrete, terpolymers of alkylacrylates, copolymers and terpolymers of styrene, polyamides, other polyolefins, and blends of condensation polymers with natural or synthetic rubber. The thermoplastic material of the liner may also include conventional additives known to those skilled in the art such as a slip agent.

The preform 110, container 122, and packaged beverage 138 are but examples of suitable embodiments of the present invention. It should be understood that the polyester composition of the present invention can be used to make preforms and containers having a variety of configurations.

The present invention is described above and further illustrated below by an example which is not to be construed in any way as imposing limitations upon the scope of the invention. On the contrary, it is to be clearly understood that resort may be had to various other embodiments, modifications, and equivalents thereof which, after reading the description herein, may suggest themselves to those skilled in the art that without departing from the scope of the invention and the appended claims.

### EXAMPLES 1 AND 2

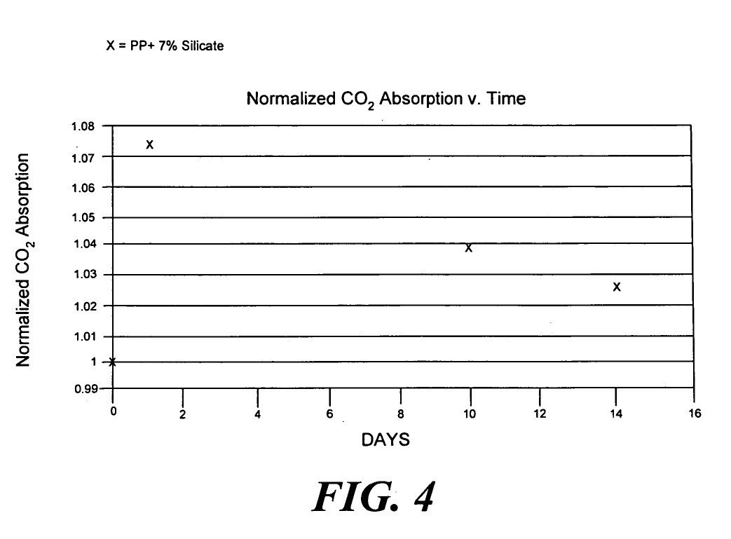

Fumed silica was incorporated into a closure grade polypropylene (PP) in a extruder and extruded into films in the amount of 7% by weight. The film was then cut into 2 inch by 2 inch ribbons for conditioning. For simplification of the experiment, 10-g of the absorptive additive containing PP was conditioned at 5.5 volume at room temperature for one week. Immediately upon the removal of the absorptive additive containing PP, the containers are filled with carbon dioxide gas to 4 volumes and capped immediately. The carbon dioxide level inside these containers is measured by FTIR as described in U.S. Pat. No. 5,473,161, incorporated herein by reference. The carbon dioxide level inside the containers is normalized and plotted against time as shown in FIG. 4. It can be seen that there is a surge of pressure in side the container due to the carbon dioxide release from the absorbed carbon dioxide that was pre-absorbed in the silica containing PP.

### EXAMPLE 3 AND 4

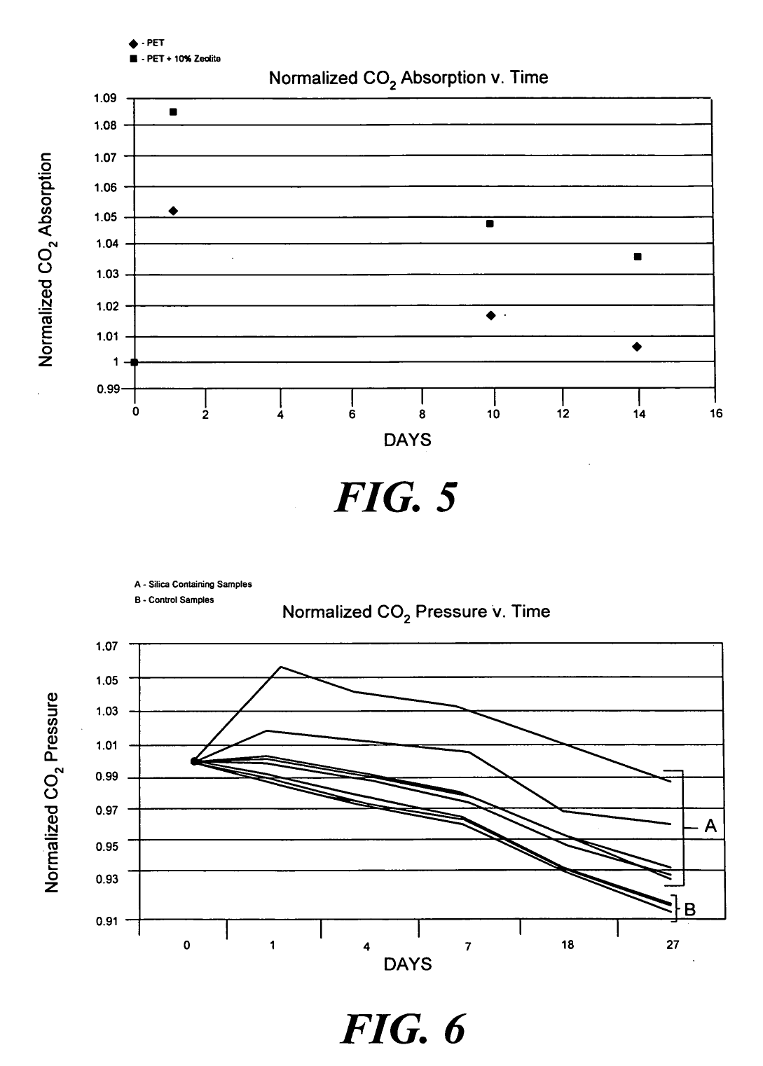

10% of zeolite were incorporated into bottle grade PET in a extruder and the mixture was extruded into films. The films were then cut into 2 in by 2 in ribbons. The same PET was also extruded and cut into similar ribbons for comparison. This experiment was used to simulate incorporating the zeolite into a PET sidewall. To simulate the normal PET bottles, 10-g of the 10% zeolite containing PET was cut into ribbons and was conditioned at 5.5 volume CO₂ at room temperature for one week. A 10-g PET is used because in the simulation test, both sides of the ribbons were within the bottle, while in the case of the bottles, only one surface was exposed to the product contact side. Since a normal 500 ml PET bottle is about 24 g, half of that amount was used for simulation. For comparison, a 10-g of PET film was also cut into ribbons and conditoned at the same condition as the zeolite containing PET. After conditioning, the PET and zeolite containing PET ribbons were removed and put in 500 ml PET bottles. Immediately upon the removal of the zeolite containing PET ribbon and PET ribbon, the containers are filled with carbon dioxide gas to 4 volumes and capped immediately. The carbon dioxide level inside these containers is measured by FTIR as described in U.S. Pat. No. 5,473,161, incorporated herein by reference. The carbon dioxide level inside the containers is normalized and plotted against time as shown in FIG. 5. It can be seen that there is a surge of pressure inside the container due to the carbon dioxide release from the absorbed carbon dioxide that was pre-absorbed in the zeolite containing PET.

### EXAMPLE 5

5-g of fumed silica were put in 24.5 g 12-oz PET bottles to simulate 20% wt of silica in a PET sidewall. The bottles were filled with dry ice to a pressure of 4.5 volumes. The same PET bottles were used as a control without fumed silica and were filled with dry ice to the pressure of 4.5 volume. 3-g of ices were added into the bottles to create 100% RH inside the bottle. The bottles were sealed with plastic closures and the carbon dioxide concentration (or pressure) inside the bottles were tracked with FTIR as described in U.S. Pat. No. 5,473,161. The carbon dioxide pressure was normalized and plotted as a function of time and shown in FIG. 6. It is seen from FIG. 6 that the bottles containing fumed silica had a pressure surge as compared with PET bottles without fumed silica. The fumed silica behaved like a reservoir to absorb the carbon dioxide, and later release the carbon dioxide back into the container after the container lost carbon dioxide through sidewall and closure permeation. The variation shown is because the carbon dioxide pressure was not normalized for silica weight, where there is measurement error. This kind of pressure surge did not happen with the containers without fused silica.

It should also be understood that the foregoing relates to particular embodiments of the present invention, and that numerous changes may be made therein without departing from the scope of the invention as defined by the following claims.

1. A container for a carbonated beverage comprising:
a closure, optionally comprising a closure liner;
a container body having a sidewall comprising a polyester composition suitable for packaging a carbonated beverage; and
a porous, absorptive inorganic additive disposed in the closure, the closure liner, the side wall, or combinations thereof, and capable of absorbing carbon dioxide.

2. A container as in claim 1 wherein the absorptive inorganic additive has a surface area greater than 100 m²/gram.

3. A container as in claim 1 wherein the absorptive inorganic additive has a surface area greater than 150 m²/gram.

4. A container as in claim 1 wherein the absorptive inorganic additive is inert to the closure, the closure liner, the polyester composition and the carbonated beverage and does not degrade at temperatures up to 300° C.

5. A container as in claim 1 wherein the absorptive inorganic additive is zeolite or fumed silica.

6. A container as in claim 1 wherein the absorptive inorganic additive is present in the closure, the closure liner, the side wall, or combinations thereof in an amount of about 3 to about 50 percent by weight of the respective closure, the closure liner, the side wall, or combinations thereof.

7. A container as in claim 1 wherein the absorptive inorganic additive is present in the closure, the closure liner, the side wall, or combinations thereof in an amount of about 3 to about 20 percent by weight of the respective closure, the closure liner, the side wall, or combinations thereof.

8. A container as in claim 1 wherein the absorptive inorganic additive is present in the closure, the closure liner, the side wall, or combinations thereof in an amount of about 3 to about 10 percent by weight of the respective closure, the closure liner, the side wall, or combinations thereof.

9. A container as in claim 1 wherein the absorptive inorganic additive is disposed in the closure liner.

10. A container as in claim 1 wherein the polyester composition comprises a poly(ethylene terephthalate) based copolymer having less than 20 mole % diacid modification and/or 10 mole % diol modification, based on 100 mole % diacid component and 100 mole % diol component.

11. A container as in claim 1 wherein the container body is a rigid container body comprising a base, an open ended mouth, and a body extending from the base to the open ended mouth.

12. A packaged carbonated beverage comprising
a container body having a sidewall comprising a polyester composition suitable for packaging a carbonated beverage;
a closure for sealing the container body, the closure optionally comprising a closure liner;
a porous, absorptive inorganic additive disposed in the closure, the closure liner, the side wall, or combinations thereof, and capable of absorbing carbon dioxide; and
a carbonated beverage disposed in the container body,
wherein the absorptive inorganic additive has been saturated with carbon dioxide prior to filling the container body with the carbonated beverage.

13. A packaged carbonated beverage as in claim 12 wherein the absorptive inorganic additive has a surface area greater than 100 m²/gram.

14. A packaged carbonated beverage as in claim 12 wherein the absorptive inorganic additive has a surface area greater than 150 m²/gram.

15. A packaged carbonated beverage as in claim 12 wherein the absorptive inorganic additive is inert to the closure, the closure liner, the polyester composition and the carbonated beverage and does not degrade at temperatures up to 300° C.

16. A packaged carbonated beverage as in claim 12 wherein the absorptive inorganic additive is zeolite or fumed silica.

17. A packaged carbonated beverage as in claim 12 wherein the absorptive inorganic additive is present in the closure, the closure liner, the side wall, or combinations thereof in an amount of about 3 to about 50 percent by weight of the respective closure, the closure liner, the side wall, or combinations thereof.

18. A packaged carbonated beverage as in claim 12 wherein the absorptive inorganic additive is present in the closure, the closure liner, the side wall, or combinations thereof in an amount of about 3 to about 20 percent by weight of the respective closure, the closure liner, the side wall, or combinations thereof.

19. A packaged carbonated beverage as in claim 12 wherein the absorptive inorganic additive is present in the closure, the closure liner, the side wall, or combinations thereof in an amount of about 3 to about 10 percent by weight of the respective closure, the closure liner, the side wall, or combinations thereof.

20. A packaged carbonated beverage as in claim 12 wherein the absorptive inorganic additive is disposed in the closure liner.

21. A packaged carbonated beverage as in claim 12 wherein the polyester composition comprises a poly(ethylene terephthalate) based copolymer having less than 20 mole % diacid modification and/or 10 mole % diol modification, based on 100 mole % diacid component and 100 mole % diol component.

22. A packaged carbonated beverage as in claim 12 wherein the container body is a rigid container body comprising a base, an open ended mouth, and a body extending from the base to the open ended mouth, and the closure seals the open ended mouth.

23. A method of enhancing carbon dioxide retention in a carbonated beverage comprising the steps of:
providing a container comprising a (a) closure optionally comprising a closure liner, (b) a container body having a sidewall comprising a polyester composition suitable for packaging a carbonated beverage, and (c) a porous, absorptive inorganic additive disposed in the closure, the closure liner, the side wall, or combinations thereof, and capable of absorbing carbon dioxide;
prior to the filling the container, saturating the absorptive inorganic additive with carbon dioxide;
filling the container with a carbonated beverage; and
sealing the container,
wherein carbon dioxide absorbed by the absorptive inorganic additive is released into the container compensating at least in part for loss of carbon dioxide from the carbonated beverage by permeation through the container.

24. A method as in claim 23 wherein the absorptive inorganic additive has a surface area greater than 100 m²/gram.

25. A method as in claim 23 wherein the absorptive inorganic additive has a surface area greater than 150 m²/gram.

26. A method as in claim 23 wherein the absorptive inorganic additive is inert to the closure, the closure liner, the polyester composition and the carbonated beverage and does not degrade at temperatures up to 300° C.

27. A method as in claim 23 wherein the absorptive inorganic additive is zeolite or fumed silica.
